(19) United States
(12) Patent Application Publication
(10) Pub. No.: US 2025/0224003 A1
(43) Pub. Date: Jul. 10, 2025

(54) SEALING ASSEMBLY FOR A WHEEL BEARING, AND WHEEL BEARING COMPRISING A SEALING ASSEMBLY

(71) Applicant: Schaeffler Technologies AG & Co. KG, Herzogenaurach (DE)

(72) Inventors: Andreas Kaiser, Werneck (DE); Christian Mock, Schweinfurt (DE); Darius Dlugai, Schwebheim (DE); Marco Krapf, Burkardroth (DE)

(73) Assignee: Schaeffler Technologies AG & Co. KG, Herzogenaurach (DE)

(21) Appl. No.: 18/850,669

(22) PCT Filed: Mar. 1, 2023
(86) PCT No.: PCT/DE2023/100162

§ 371 Date: Sep. 25, 2024

(30) Foreign Application Priority Data
Mar. 28, 2022 (DE) 10 2022 107 234.7

(51) Int. Cl. F16C 33/78; B60B 27/00; F16C 41/00; G01D 5/16

(52) U.S. Cl. CPC F16C 33/7816; B60B 27/0073; F16C 41/007; G01D 5/16; B60B 2900/511; F16C 2326/02

(57) ABSTRACT

The disclosure relates to a sealing assembly for sealing a wheel bearing for a wheel-bearing hub of a vehicle. The sealing assembly includes a sealing unit connected to an outer ring of the wheel bearing for conjoint rotation, and a centrifugal disc connected to an inner ring of the wheel bearing for conjoint rotation. The sealing unit has a sealing carrier and a sealing element arranged on the sealing carrier, and the centrifugal disc has an encoder on an outer end face. The encoder provides magnetic fields, and has a peripheral recess extending in an axial direction and radially outwardly delimits a magnetization region of the encoder. The disclosure also relates to a wheel bearing for a wheel-bearing hub of a vehicle. The wheel bearing includes a rotatable inner ring having an inner ring race, a fixed outer ring having an outer ring race, and a plurality of rolling elements.

### CROSS-REFERENCE TO RELATED APPLICATIONS

This application is the U.S. National Phase of PCT Application No. PCT/DE2023/100162 filed on Mar. 1, 2023, which claims priority to DE 10 2022 107 234.7 filed on Mar. 28, 2022, the entire disclosure of which is incorporated by reference herein.

### TECHNICAL FIELD

The present disclosure relates to a sealing assembly for sealing a wheel bearing for a wheel bearing hub, in particular for a wheel bearing hub with a spur toothing of a vehicle.

### BACKGROUND

Seals for sealing a wheel bearing are sufficiently well known in the prior art. For example, so-called cassette seals are used to seal wheel bearings in passenger cars or trucks. The seals are used to protect a rolling element chamber of the wheel bearing against foreign substances entering from outside, such as water, dirt particles and so forth. Here, the seals are usually designed as two-part assemblies, wherein a first assembly is connected to a fixed element of the wheel bearing, for example to the outer ring of the wheel bearing, and a second assembly is connected to a rotatable element of the wheel bearing, for example to the inner ring of the wheel bearing.

Furthermore, the seals, in particular on the second assembly, can have an encoder element that provides signals, in particular in the form of magnetic fields, which are detected by a sensor, for example a speed sensor, and forwarded to a control unit for evaluation. In this regard, the geometry and/or the alignment of the encoder is matched to the sensor position.

It has now become apparent that there is a further need to improve a known sealing assembly for sealing a wheel bearing. In particular, there is a further need to provide a sealing assembly for sealing a wheel bearing, which enables or ensures a positioning of the encoder in a manner matched to a sensor position essentially independently of a design of the wheel bearing.

Against this background, it is the object of the present disclosure to provide an improved sealing assembly for sealing a wheel bearing for a wheel bearing hub of a vehicle as well as an improved wheel bearing for a wheel bearing hub of a vehicle, which in particular enables or ensures a positioning of the encoder in a manner matched to a sensor position essentially independently of a design of the wheel bearing.

### SUMMARY

This and other objects that could be mentioned or recognized by a person skilled in the art upon reading the following description are achieved by the subject matters described herein. Advantageous embodiments and further developments can be found in the following description.

The sealing assembly according to the disclosure for sealing a wheel bearing for a wheel bearing hub, in particular for a wheel bearing hub with a spur toothing, of a vehicle, for example a passenger car or a truck, has a sealing unit and a centrifugal disc. The sealing unit is designed to be connected to an outer ring of the wheel bearing for conjoint rotation and, if necessary, in an axially fixed manner. The centrifugal disc is designed to be connected to an inner ring of the wheel bearing for conjoint rotation and, if necessary, in an axially fixed manner. The sealing unit has a sealing carrier and a sealing element which is arranged on the sealing carrier. The centrifugal disc has an encoder on an outer end face in relation to the sealing interior of the sealing assembly, which encoder is designed to provide magnetic fields. In this regard, the encoder has a circumferential recess which extends in the axial direction and radially outwardly limits a magnetization region of the encoder.

The advantage of the solution according to the disclosure lies in particular in the fact that the circumferential recess makes it possible to define the magnetization region of the encoder and thus a magnetic field course, in particular in the radial direction. This makes it possible to position the magnetization region or the magnetic field course independently of a wheel bearing configuration, relative to a sensor position. Generally, the sensor position is predetermined in a fixed manner, which is why the encoder must be arranged relative to this predetermined sensor position.

The encoder is a section that provides signals that are designed to be detected by a sensor. The magnetization region of the encoder has evenly distributed regions of differing magnetic polarity around the circumference, i.e., magnetic north and south poles are arranged in an alternating manner along the circumferential direction. In particular, the signals from the encoder can be magnetic fields that can be detected by a magnetoresistive sensor. A magnetic field has magnetic field components that are pronounced in all three spatial directions, i.e., in the x-direction, in the y-direction and in the z-direction. In the following and by way of example, the x-direction corresponds to a tangential direction or a circumferential direction of the encoder, the y-direction corresponds to a radial direction of the encoder and the z-direction corresponds to an axial direction of the encoder in this regard. The magnetic field components are sinusoidal in the circumferential direction, wherein the different magnetic field components each have different amplitudes. This results in multiple regions over a radial width in which the various magnetic field components are stronger or weaker.

Magnetoresistive sensors, in particular magnetoresistive speed sensors, which react to the x-component of the magnetic field, for example, are also sensitive to transverse fields, i.e., magnetic fields in the y-direction and/or in the z-direction. If such a transverse field is too high in a reading region of the sensor, the sensor may be disturbed in its operation, which may result, for example, in incorrect detection of a pulse number. In other words, it can be said that the signal detection of the sensor can be improved if the reading region of the sensor detects a region of the magnetic field in which the amplitudes of the desired magnetic field component, for example the x-component, are as high as possible and at the same time the amplitudes of the other magnetic field components, for example the y-and/or z-component, are as low as possible.

The circumferential recess, in particular the positioning of the circumferential recess in the radial direction, can reduce or even prevent an erroneous signal detection, for example due to lateral interference fields, in particular in the case of sensors that are sensitive in multiple axes. It is also possible to design the wheel bearing in such a way that the service life can be increased. In particular, a wheel bearing with a high pitch circle diameter can be used without substantially influencing the position or a radial dimension of the magnetization region of the encoder.

According to an example embodiment, the magnetization region of the encoder is designed to define a detection region which is designed to be detected by a sensor, in particular a speed sensor.

As seen in the radial direction, the detection region is arranged approximately centrally, in particular slightly off-center, in relation to the magnetization region. This means that the size of the magnetization region in the radial direction can be used to influence or determine the positioning of the detection region in the radial direction. This means that the radial position and radial height of the magnetization region can be selected such that the detection region, which has the desired magnetic field characteristics, i.e., the desired strength of the magnetic fields in the three spatial directions, is arranged in the reading region of the sensor. This improves the signal detection by the sensor.

According to an example embodiment, the circumferential recess is designed to position the detection region relative to the sensor. The sensor has a reading region in which it detects the signals provided by the encoder, in particular the magnetic fields. Thus, the positioning of the magnetization region or the detection region of the encoder relative to the reading region of the sensor determines the quality of the signal detection. An optimal alignment of the detection region of the encoder relative to the reading region of the sensor essentially corresponds to a positioning of the detection region in the reading region of the sensor. This can serve to reduce or prevent the influence of lateral interference fields on signal detection, in particular in the case of sensors that are sensitive in multiple axes.

According to an example embodiment, the encoder has an elastomer-like carrier material, such as a rubber material, with magnetizable particles, in particular with ferrite particles. This makes it possible to integrate the encoder into a sealing material. This means that the elastomer-like carrier material also serves as a sealing material and the magnetizable particles are used to generate magnetic fields. The encoder is thus integrated into the sealing assembly in a manner that saves on installation space.

According to an example embodiment, the magnetizable particles, which are arranged radially inside of the circumferential recess, have a permanent magnetization state. The magnetizable particles introduced into the elastomer-like carrier material are initially not magnetized. The magnetization of the magnetizable particles only takes place in the further course of the manufacturing process of the encoder or sealing assembly. In this regard, it is particularly cost-effective if the magnetizable particles are arranged in an evenly distributed manner throughout the entire mass of the elastomer-like carrier material. In the further course of the manufacturing process, the circumferential recess prevents magnetization of the magnetizable particles, which are arranged in the elastomer-like carrier material radially outside of the circumferential recess. In other words, it can be said that the circumferential recess limits magnetization and thus enables the magnetic fields to be formed in a targeted manner. Furthermore, this makes a positioned magnetization possible, which can be influenced by the positioning of the circumferential recess in the radial direction.

A further aspect of the disclosure relates to a wheel bearing for a wheel bearing hub, in particular for a wheel bearing hub with a spur toothing, of a vehicle, for example a passenger car or a truck. The wheel bearing has a rotatable inner ring having an inner ring race, a fixed outer ring having an outer ring race, a plurality of rolling elements which are arranged between the inner ring and the outer ring in such a way that they roll along the inner ring race and the outer ring race when the inner ring rotates relative to the outer ring, and a sealing assembly which is used to seal the wheel bearing. In this regard, the sealing assembly has a sealing unit and a centrifugal disc. In this regard, the sealing unit is connected to the outer ring of the wheel bearing for conjoint rotation and, if necessary, in an axially fixed manner. The centrifugal disc is connected to the inner ring of the wheel bearing for conjoint rotation and, if necessary, in an axially fixed manner. The sealing unit further has a sealing plate and a sealing element with at least one sealing lip, in particular two or more sealing lips, wherein the sealing element is arranged on the sealing plate. The centrifugal disc has an encoder on an outer end face in relation to the sealing interior of the sealing assembly, which encoder is designed to provide magnetic fields. In this regard, the encoder has a circumferential recess which extends in the axial direction and radially outwardly limits a magnetization region of the encoder.

The circumferential recess makes it possible to define the magnetization region of the encoder and thus a magnetic field course. This makes it possible to position the magnetization region or the magnetic field course independently of a wheel bearing configuration relative to a sensor position. Generally, the sensor position is predetermined in a fixed manner, which is why the encoder must be arranged relative to this predetermined sensor position.

The encoder is a section that provides signals that are designed to be detected by a sensor. The magnetization region of the encoder has evenly distributed regions of differing magnetic polarity around the circumference, i.e., magnetic north and south poles are arranged in an alternating manner along the circumferential direction. In particular, the signals from the encoder can be magnetic fields that can be detected by a magnetoresistive sensor. A magnetic field has magnetic field components that are pronounced in all three spatial directions, i.e., in the x-direction, in the y-direction and in the z-direction. In the following and by way of example, the x-direction corresponds to a tangential direction or a circumferential direction of the encoder, the y-direction corresponds to a radial direction of the encoder and the z-direction corresponds to an axial direction of the encoder in this regard. The magnetic field components are sinusoidal in the circumferential direction, wherein the different magnetic field components each have different amplitudes. This results in multiple regions over a radial width in which the various magnetic field components are stronger or weaker.

Magnetoresistive sensors, in particular magnetoresistive speed sensors, which react to the x-component of the magnetic field, for example, are also sensitive to transverse fields, i.e., magnetic fields in the y-direction and/or in the z-direction. If such a transverse field is too high in a reading region of the sensor, the sensor may be disturbed in its operation, which may result, for example, in incorrect detection of a pulse number. In other words, it can be said that the signal detection of the sensor can be improved if the reading region of the sensor detects a region of the magnetic field in which the amplitudes of the desired magnetic field component, for example the x-component, are as high as possible and at the same time the amplitudes of the other magnetic field components, for example the y- and/or z-component, are as low as possible.

The circumferential recess, in particular the positioning of the circumferential recess in the radial direction, can reduce or even prevent an erroneous signal detection, for example due to lateral interference fields, in particular in the case of sensors that are sensitive in multiple axes. It is also possible to design the wheel bearing in such a way that the service life can be increased. In particular, a wheel bearing with a high pitch circle diameter can be used without substantially influencing the position or a radial dimension of the magnetization region of the encoder.

According to an example embodiment, the encoder extends in the radial direction to below a sealing seat, i.e., radially further inwards than the sealing seat, of the centrifugal disc. This makes it possible to arrange the encoder relative to the sensor position, independent of the inner ring height, in particular the height of an inner ring rim. This makes it possible to increase a pitch circle diameter of the wheel bearing and/or a diameter of the inner ring rim without changing or shifting the position of the detection region of the encoder. In other words, it can be said that the pitch circle diameter and/or the inner ring rim can be increased, wherein a reading diameter of the sensor can be maintained at the same time.

According to an example embodiment, the wheel bearing further has an interface seal which extends essentially in the axial direction and is designed to seal an interface or a connection point between the wheel bearing hub and a hinged bell, wherein a radially inner end of the encoder is arranged in the axial direction between the inner ring and the interface seal.

In this regard, the interface seal can have a radial rim that extends radially outwardly at an axial end facing the wheel bearing. Due to tolerances, for example manufacturing tolerances, a gap may be formed between the inner ring, in particular the inner ring rim, and the interface seal in the axial direction, which may be exposed to corrosion in an operating state of the wheel bearing. The arrangement of the radially inner end of the encoder in the axial direction between the inner ring and the interface seal makes it possible to reduce or close the gap in the axial direction and thus reduce or prevent corrosion in this region. In particular, the radially inner end of the encoder can be pinched or clamped between the inner ring and the interface seal as seen in the axial direction. The interface seal can also be referred to as an orbitally formed shoulder seal.

According to an example embodiment, the radially inner end of the encoder has a first projection which extends in the axial direction and is designed to be in contact with the interface seal in a sealing manner. Additionally or alternatively, the radially inner end of the encoder has a second projection which extends in the axial direction and is designed to be in contact with the inner ring in a sealing manner.

When coming into contact with the interface seal and/or the inner ring, the first projection and/or the second projection establish an axially circumferential and sealing line contact. In addition, the projections can be used to increase, in particular double, a permissible tolerance for an axial positioning of the radially inner end of the encoder.

### BRIEF DESCRIPTION OF THE DRAWINGS

Further measures to improve the disclosure are shown in more detail below together with the description of an example embodiment of the disclosure based on the figures. In the figures:

FIG. 1 shows a schematic partial representation of a wheel bearing according to an example embodiment of the disclosure,

FIG. 2 shows schematic partial representations of wheel bearings, wherein FIG. 2(a) depicts a wheel bearing according to an example embodiment of the disclosure, and FIG. 2(b) depicts a wheel bearing known from the prior art; and

FIG. 3 shows schematic partial representations of wheel bearings, wherein FIG. 3(a) depicts a wheel bearing according to an example embodiment of the disclosure and FIG. 3(b) depicts a wheel bearing according to a further example embodiment of the disclosure.

### DETAILED DESCRIPTION

The figures are only schematic in nature and serve only for understanding of the disclosure. Identical elements are provided with the same reference signs.

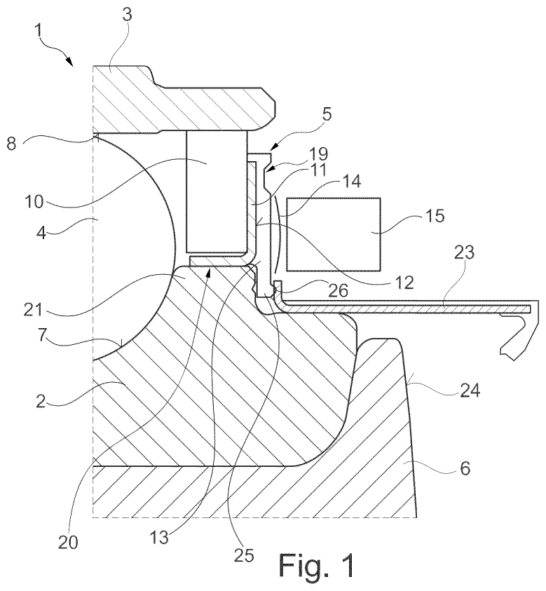

FIG. 1 shows an exemplary wheel bearing 1 according to an example embodiment of the disclosure in a sectional view. The wheel bearing 1 has an inner ring 2, an outer ring 3, rolling elements 4 and a sealing assembly 5. The inner ring 2 is coupled with a rotatable wheel hub 6 for conjoint rotation and the outer ring 3 is coupled with a fixed element, for example a housing section (not shown), for conjoint rotation. A plurality of rolling elements 4 are arranged between the inner ring 2 and the outer ring 3, which roll along an inner ring race 7 and an outer ring race 8 during a relative movement between the inner ring 2 and the outer ring 3.

The sealing assembly 5 is arranged in a gap between the inner ring 2 and the outer ring 3 and is designed to reduce or prevent the ingress of dirt particles, such as water, mud, etc., into a rolling element chamber 9 of the wheel bearing 1, in which the rolling elements 4 are arranged. The sealing assembly 5 has a sealing unit 10 and a centrifugal disc 11, wherein the sealing unit 10, which is shown here in a simplified form as a block, is coupled with the outer ring 3 for conjoint rotation and in an axially fixed manner. The centrifugal disc 11 is coupled with the inner ring 2 of the wheel bearing 1 for conjoint rotation and in an axially fixed manner and has an encoder 13 on an outer end face 12 facing away from the rolling element chamber 9.

The encoder 13 is formed from an elastomer-like carrier material, such as a rubber material, with magnetizable particles, which at least partially have a magnetized permanent state and in this state form a magnetic field 14 that can be detected by a magnetoresistive sensor 15. The sensor 15 has a reading region that is designed to detect the magnetic field 14. The position of the sensor 15 is usually predetermined, so that the encoder 13 must be arranged relative to the sensor 15 in such a way that the reading region of the sensor 15 can detect the magnetic field 14 with as little interference as possible. The sensor 15 is in particular a speed sensor, for example an ABS sensor, i.e., a sensor that is used to control the anti-lock braking system (ABS) of a vehicle.

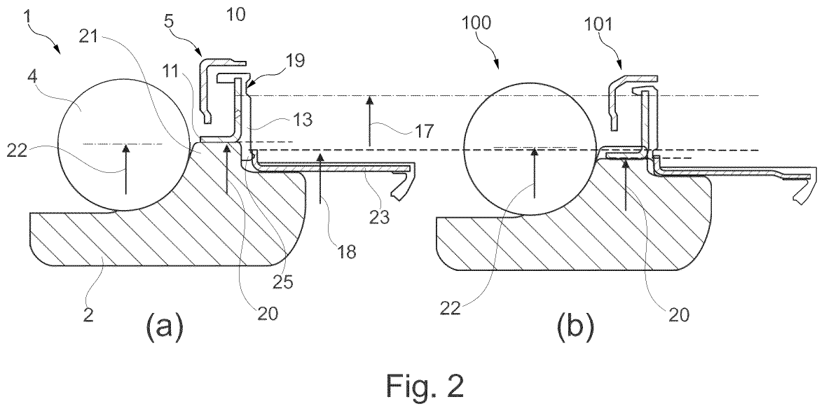

The position and formation of the magnetic field 14 is dependent on a magnetization region 16 of the encoder 13 in the radial direction R. The magnetization region 16 can also be referred to as the track width 16, and corresponds to half the difference between an outside diameter 17 and an inside diameter 18 of the encoder 13 (see FIG. 2), wherein a detection region, which is arranged approximately centrally or slightly off-center in relation to the track width 16 in the radial direction R, is arranged in the reading region of the sensor 15 in order to reduce the influence of lateral interference fields and other sources of error and thus improve the signal detection by the sensor 15.

According to an example embodiment of the disclosure, the encoder 13 has a circumferential recess 19 which extends in the axial direction A. The circumferential recess 19 is designed to prevent magnetization of the magnetizable particles, which are arranged in the rubber material radially outside of the recess 19. In other words, it can be said that the recess 19 radially outwardly limits the magnetization of the magnetizable particles and thus the formation of the track width. In addition, the encoder 13 projects radially inwards to below a sealing seat 20. The sealing seat 20 describes the position at which the centrifugal disc 11 is arranged on the inner ring 2, in particular by means of an interference fit.

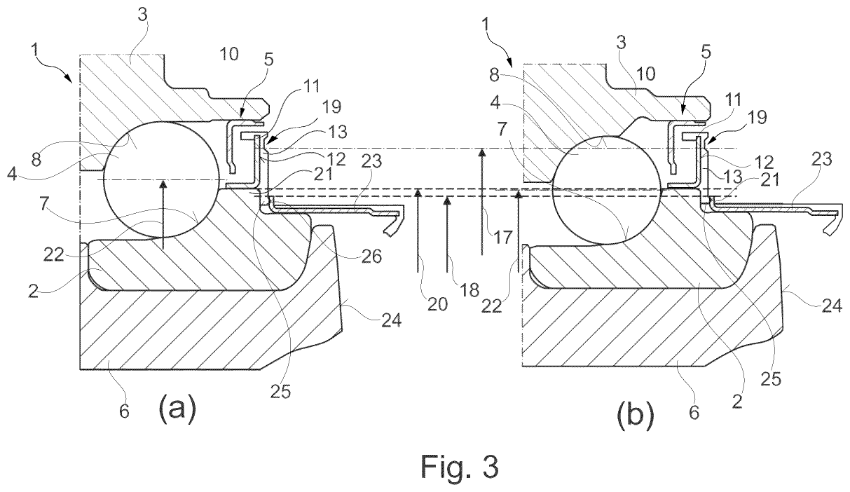

It is thus possible to determine the outside diameter 17 of the encoder 13 by positioning the recess 19 in the rubber material of the encoder 13, thereby radially outwardly limiting the track width 16. In addition, it is possible to extend the encoder 13 radially inwards beyond the sealing seat 20 and thus determine the inside diameter 18 of the encoder 13, thereby radially inwardly limiting the track width 16. It is thus possible to determine the position of the encoder 13 independently of a position of the sealing seat 20, which makes it possible to align the encoder 13 relative to the reading region of the sensor 15 (see FIG. 1) independently of the design of the wheel bearing 1, as illustrated by way of example in FIGS. 2(a) and 2(b) and FIGS. 3(a) and 3(b). Furthermore, the design of the wheel bearing 1 can thus be selected essentially independently of the predetermined position of the sensor 15, which makes it possible to adapt the wheel bearing 1 to the forces acting on the wheel bearing 1 in an operating state and thus, in particular, to improve the service life of the wheel bearing 1.

FIG. 2(a) shows a partial section of the wheel bearing 1 according to an example embodiment of the disclosure and FIG. 2(b) shows a partial section of an exemplary wheel bearing 100 known from the prior art. It can be seen that for an identical arrangement of the track width 16 of the encoder 13, the sealing assembly 5 according to an example embodiment of the disclosure makes it possible to use a wheel bearing 1 with a higher inner ring rim 21 and thus a sealing seat 20 positioned radially further outwards than a sealing assembly 101 known from the prior art.

FIGS. 3(a) and 3(b) each show a partial section of the wheel bearing 1 according to an example embodiment of the disclosure. Looking at FIGS. 3(a) and 3(b), it can be seen that the sealing assembly 5 also makes it possible to vary a pitch circle diameter 22 without changing the position of the track width 16 of the encoder 13.

The wheel bearings 1, as shown in FIGS. 1, 2(a), 3(a) and 3(b) in various exemplary embodiments, further each have an interface seal 23, which can also be referred to as an orbitally formed shoulder seal. The interface seal 23 is designed to seal an axial interface between the wheel hub 6 and a further element, such as a hinged bell (not shown). In particular, the interface can be designed as a toothing engagement between a spur toothing 24 of the wheel hub 6 and a spur toothing (not shown) formed in a corresponding manner on the further element.

An axial position of the interface seal 23 can vary due to tolerances, whereby a gap can be formed between the interface seal 23 and the inner ring 2. By positioning a radially inner encoder end 25 in the axial direction A between the inner ring 2 and the interface seal 23, such a gap can be sealed and thus protected against corrosion. In particular, the radially inner encoder end 25 is clamped or pinched between the inner ring 2 and the interface seal 23, so that it is in contact with both the inner ring 2 and the interface seal 23 in a sealing manner. In addition, a circumferential projection 26 is formed at the radially inner encoder end 25, which extends in the axial direction A towards the interface seal 23. In particular, the projection 26 is formed in a conical manner, i.e., tapering towards the interface seal 23, and thus establishes an axially circumferential and sealing line contact at the interface seal 23. Furthermore, such a projection can additionally or alternatively be formed in the axial direction A towards the inner ring 2 (not shown). The at least one projection 26 makes it possible to increase a tolerance for the axial positioning of the interface seal 23, in particular to double it with one projection 26 on each side of the radially inner end 25.

### List of Reference Symbols

1 Wheel bearing
2 Inner ring
3 Outer ring
4 Rolling element
5 Sealing assembly
6 Wheel hub
7 Inner ring race
8 Outer ring race
9 Rolling element chamber
10 Sealing unit
11 Centrifugal disc
12 End face
13 Encoder
14 Magnetic field
15 Sensor
16 Magnetization region/track width
17 Outside diameter
18 Inside diameter
19 Recess
20 Sealing seat
21 Inner ring rim
22 Pitch circle diameter
23 Interface seal
24 Spur toothing
25 Radially inner end
26 Projection
100 Wheel bearing (prior art)
101 Sealing assembly (prior art)
A Axial direction
R Radial direction

1. A sealing assembly for sealing a wheel bearing for a wheel bearing hub of a vehicle, the sealing assembly comprising:
a sealing unit configured to be connected to an outer ring of the wheel bearing for conjoint rotation, the sealing unit having a sealing carrier and a sealing element arranged on the sealing carrier, and
a centrifugal disc configured to be connected to an inner ring of the wheel bearing for conjoint rotation, the centrifugal disc having an encoder on an outer end face, the encoder configured to provide magnetic fields, and
wherein the encoder has a circumferential recess extending in an axial direction and the circumferential recess radially outwardly limits a magnetization region of the encoder.

2. The sealing assembly according to claim 1, wherein the magnetization region of the encoder defines a detection region configured to be detected by a sensor.

3. The sealing assembly according to claim 2, wherein the circumferential recess is configured to position the detection region relative to the sensor.

4. The sealing assembly according to claim 3, wherein the encoder has an elastomer carrier material with magnetizable particles.

5. The sealing assembly according to claim 4, wherein the magnetizable particles, are arranged radially inside of the circumferential recess, and have a permanent magnetization state.

6. A wheel bearing for a wheel bearing hub of a vehicle, the wheel bearing comprising:
a rotatable inner ring having an inner ring race,
a fixed outer ring having an outer ring race,
a plurality of rolling elements arranged between the rotatable inner ring and the fixed outer ring so as to roll along the inner ring race and the outer ring race when the rotatable inner ring rotates relative to the fixed outer ring, and
a sealing assembly configured to seal the wheel bearing, the sealing assembly having:
a sealing unit connected to the fixed outer ring of the wheel bearing for conjoint rotation,
a sealing carrier and a sealing element arranged on the sealing carrier,
a centrifugal disc connected to the rotatable inner ring of the wheel bearing for conjoint rotation, the centrifugal disc having an encoder on an outer end face, the encoder:
configured to provide magnetic fields, and
having a circumferential recess extending in an axial direction, the circumferential recess radially outwardly limiting a magnetization region of the encoder.

7. The wheel bearing according to claim 6, wherein the encoder extends in the a radial direction below a sealing seat of the centrifugal disc.

8. The wheel bearing according to claim 7, further comprising an interface seal extending essentially in the axial direction and is configured to seal an interface between the wheel bearing hub and a hinged bell, and a radially inner end of the encoder is arranged in the axial direction between the rotatable inner ring and the interface seal.

9. The wheel bearing according to claim 8, wherein the radially inner end of the encoder has a first projection extending in the axial direction and the first projection is configured to be in sealing contact with the interface seal.

10. The wheel bearing according to claim 9, wherein the radially inner end of the encoder has a second projection extending in the axial direction and the second projection is configured to be in sealing contact with the rotatable inner ring.

11. A wheel bearing for a wheel bearing hub of a vehicle, the wheel bearing comprising:
an inner ring having an inner ring race,
an outer ring having an outer ring race,
a plurality of rolling elements arranged to rollingly engage the inner ring race and the outer ring race, and
a sealing assembly configured to seal the wheel bearing, the sealing assembly having:
a sealing unit connected to one of the outer ring or the inner ring for conjoint rotation,
a sealing carrier and a sealing element arranged on the sealing carrier,
a centrifugal disc connected to a remaining one of the outer ring or the inner ring for conjoint rotation, the centrifugal disc having an encoder on an outer end face, the encoder:
configured to provide magnetic fields, and
having a circumferential recess extending in an axial direction, the circumferential recess radially outwardly limiting a magnetization region of the encoder.

12. The wheel bearing according to claim 11, wherein the magnetization region of the encoder defines a detection region configured to be detected by a sensor.

13. The wheel bearing according to claim 12, wherein the circumferential recess is configured to position the detection region relative to the sensor.

14. The wheel bearing according to claim 11, wherein the encoder has an elastomer carrier material with magnetizable particles.

15. The wheel bearing according to claim 14, wherein magnetizable particles are arranged radially inside of the circumferential recess and have a permanent magnetization state.

16. The wheel bearing according to claim 11, wherein the encoder extends in a radial direction below a sealing seat, the sealing seat defining a position at which the centrifugal disc sealingly engages the inner ring.

17. The wheel bearing according to claim 16, wherein the centrifugal disc is sealingly engaged with the inner ring via an interference fit.

18. The wheel bearing according to claim 16, further comprising an interface seal extending in the axial direction and configured to seal an axial interface on the wheel bearing hub, and a radially inner end of the encoder is arranged in the axial direction between the inner ring and the interface seal.

19. The wheel bearing according to claim 18, wherein the radially inner end of the encoder has a first projection extending in the axial direction and the first projection is configured to be in sealing contact with the interface seal.

20. The wheel bearing according to claim 19, wherein the radially inner end of theencoder has a second projection extending in the axial direction and the second projection is configured to be in sealing contact with the inner ring.
